(19) United States
(12) Patent Application Publication
(10) Pub. No.: US 2021/0011879 A1
(43) Pub. Date: Jan. 14, 2021

(54) NON-TRANSITORY COMPUTER READABLE MEDIUM STORING APPLICATION PROGRAM AND NON-TRANSITORY COMPUTER READABLE MEDIUM STORING SOFTWARE AGENT

(71) Applicant: FUJI XEROX CO., LTD., Tokyo (JP)

(72) Inventor: Kei OTSU, Kanagawa (JP)

(73) Assignee: FUJI XEROX CO., LTD., Tokyo (JP)

(21) Appl. No.: 16/785,669

(22) Filed: Feb. 10, 2020

(30) Foreign Application Priority Data
Jul. 12, 2019 (JP) 2019-129864

(51) Int. Cl. G06F 16/11; G06F 16/16; G06F 16/172

(52) U.S. Cl. CPC G06F 16/11; G06F 16/172; G06F 16/162

(57) ABSTRACT

A non-transitory computer readable medium storing an application program causes a computer to execute a function of generating a file including both or one of information related to an individual function of the application program and information dynamically changing in accordance with an execution of the application program or the individual function, and a function of notifying a software agent residing on the computer of a place where the file is stored.

### CROSS-REFERENCE TO RELATED APPLICATIONS

This application is based on and claims priority under 35 USC 119 from Japanese Patent Application No. 2019-129864 filed Jul. 12, 2019.

### BACKGROUND

### (i) Technical Field

The present invention relates to a non-transitory computer readable medium storing an application program and a non-transitory computer readable medium storing a software agent.

### (ii) Related Art

A mechanism in which hardware information, software information, and user information of a terminal apparatus are registered in a server side database through a software agent installed in the terminal apparatus of the user to be managed is proposed. However, the collected information is static information which is able to be managed by a basic software. For example, in a case of the software information, the basic software and version information thereof and installed software and version information thereof become a target to be collected.

Examples of related art include JP2002-366736A.

### SUMMARY

As described above, information collected by the software agent which is currently used is collected in unit of an installed application program, and is not provided with an individual function prepared for each application program, and a function of individually collecting information that dynamically changes in accordance with an execution of an application program or each function. In order to collect the information, it is required to register to the software agent in advance as information to be collected. However, a storage place of information to be collected is different from each application program. Thus, it is required to prepare a software agent corresponding to the application program installed in a terminal apparatus to be managed. However, a workload for correcting the software agent is large.

Aspects of non-limiting embodiments of the present disclosure relate to a non-transitory computer readable medium storing an application program and a non-transitory computer readable medium storing a software agent that enable a collection of information designated for each application program without preparing a software agent dedicated to an application program installed in a terminal apparatus to be managed.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided a non-transitory computer readable medium storing an application program causing a computer to execute a function of generating a file including both or one of information related to an individual function of the application program and information dynamically changing in accordance with an execution of the application program or the individual function, and a function of notifying a software agent residing on the computer of a place where the file is stored.

### BRIEF DESCRIPTION OF THE DRAWINGS

Exemplary embodiment(s) of the present invention will be described in detail based on the following figures, wherein:

FIG. 1 is a diagram schematically showing an example of an overall configuration of an information processing system used in an exemplary embodiment;

FIG. 2 is a diagram for explaining a functional configuration of an information processing system used in the exemplary embodiment;

FIG. 3 is a diagram for explaining an arrangement example of an application incorporating an information collection framework;

FIG. 4 is a diagram showing a specific example of a unique information file;

FIG. 5 is a diagram for explaining an example of a structure of a storage destination information DB;

FIG. 6 is a diagram for explaining a processing operation example in a case where a new application is installed in a client terminal;

FIG. 7 is a diagram for explaining an example of a processing operation executed in a client terminal after activating an application; and

FIG. 8 is a diagram for explaining an example of a processing operation in a case where an application is uninstalled from a client terminal.

### DETAILED DESCRIPTION

Hereinafter, an exemplary embodiment of the present invention will be explained by referring to the drawings.

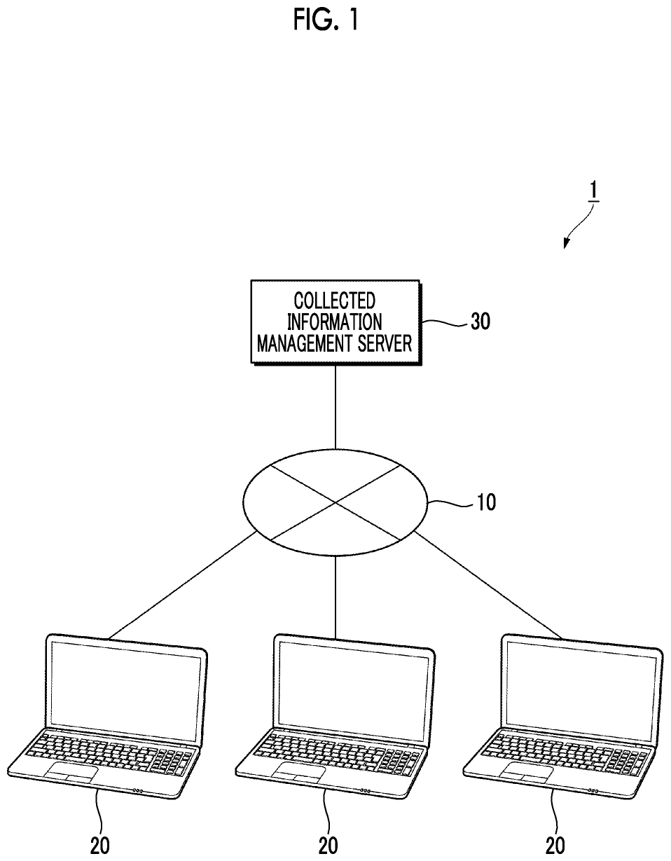

FIG. 1 is a diagram schematically showing an example of an overall configuration of an information processing system 1 used in the exemplary embodiment.

The information processing system 1 shown in FIG. 1 includes a plurality of client terminals 20 connected to a network 10 and one collected information management server 30. Here, the network may be a Local Area Network (LAN) or the Internet.

The collected information management server 30 according to the exemplary embodiment is an example of a device for automatically collecting and managing information designated for each application program (hereinafter, referred to as “application”) installed in the client terminal 20 from the client terminal 20. The contents and types of information to be collected vary depending on the application. In the exemplary embodiment, not only the applications before and after a version upgrade but also the applications before and after an update are treated as different applications.

For example, the collected information management server 30 manages information indicating whether each function included in each application that is a target of information collection is valid or invalid, a usage time and the number of times of executions as an application, a usage time by function and the number of times of executions by function, and the number and quantity of consumables consumed accompanying a specific function. The collected information management server 30 collects and manages information only for the application which is a target installed in the client terminal 20 determined to be managed.

The collected information management server 30 according to the exemplary embodiment includes a system control unit that controls a movement of an entire server, a storage device that stores basic software and firmware, and a communication interface used for communication with the network 10. The system control unit includes a Central Processing Unit (CPU), a Read Only Memory (ROM) storing a Basic Input Output System (BIOS) or the like, a Random Access Memory (RAM) used as a work area, and the like. As the storage device, a hard disk device or a rewritable nonvolatile semiconductor memory is used.

The client terminal 20 according to the exemplary embodiment includes not only a so-called computer and a server but also a network device for executing an application. Examples of the network device here include an image forming apparatus with a scanner function or a facsimile function in addition to a print function, an information terminal such as a smartphone and a tablet terminal, a health device or a medical device, and Internet of Things (IoT) household appliances including an air conditioner, a television, and a refrigerator. However, it is not limited to the exemplified devices as long as the functional configuration which will be described later is possible.

The client terminal 20 according to the exemplary embodiment also includes a system control unit that controls a movement of the entire terminal, a storage device that stores basic software and firmware, and a communication interface used for communication with the network 10. The system control unit includes a CPU, a ROM storing a BIOS and the like, a RAM used as a work area, and the like. As the storage device, a hard disk device or a rewritable nonvolatile semiconductor memory is used.

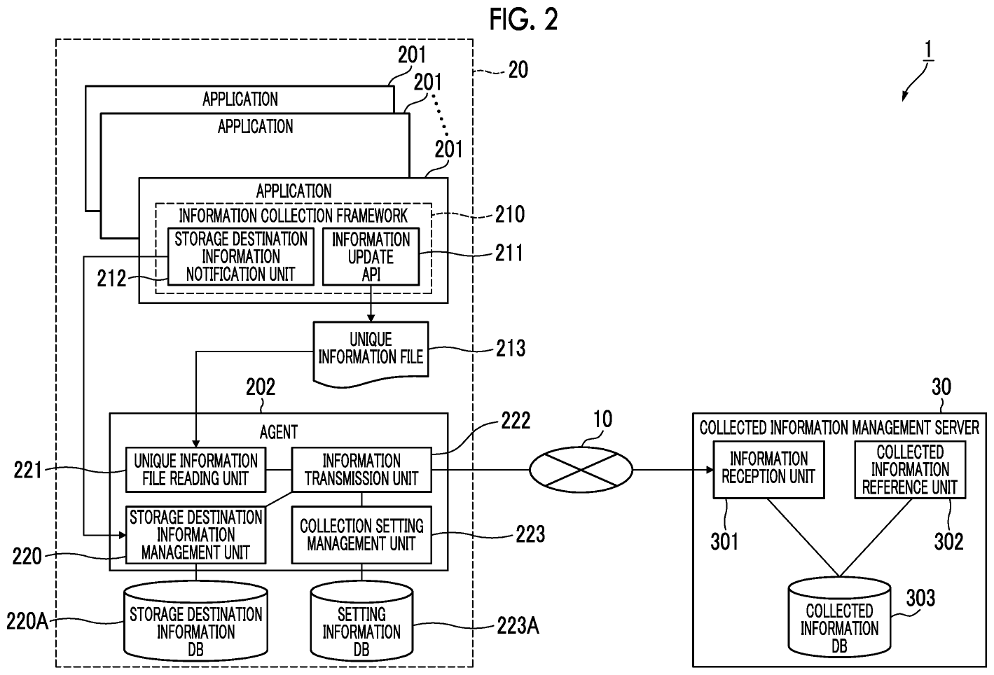

FIG. 2 is a diagram for explaining a functional configuration of the information processing system 1 used in the exemplary embodiment.

The functional configuration shown in FIG. 2 is realized through an execution of a program by a CPU of the client terminal 20 or the collected information management server 30. In FIG. 2, specific data stored in the storage device provided in the client terminal 20 or the collected information management server 30 is indicated as a database (DB).

A plurality of applications 201 are installed in the client terminal 20. All of the applications 201 used in the exemplary embodiment are targets to be managed by the collected information management server 30.

The application 201 according to the exemplary embodiment includes an information collection framework 210 for collecting information designated as a target of collection by a vendor of the application 201.

In a case of the exemplary embodiment, the information collection framework 210 includes an information update Application Programming Interface (API) 211 and a storage destination information notification unit 212.

The information collection framework 210 is prepared for each application 201, and information to be collected is determined for each application 201. The information which is a target to be collected is designated, for example, by the vendor of the application 201.

The information which is a target to be collected is described in the information update API 211. The information collected according to the description of the information update API 211 is recorded in a storage destination prepared at the time of installation as a unique information file 213.

Here, the unique information file 213 is prepared for each application 201. The unique information file 213 is updated, for example, at the timing of an update or a version upgrade. By the update of the information update API 211, the information which is the target to be collected is able to be added or deleted.

In the information update API 211 according to the exemplary embodiment, the timing for updating information of the unique information file 213 is also defined. For the timing, any timing is able to be designated without being limited to the time of the update or the version upgrade of the application 201.

The storage destination information notification unit 212 notifies the software agent (hereinafter, referred to as “agent”) 202 residing on the client terminal 20 of a place where the unique information file 213 is stored. By being provided with the storage destination information notification unit 212, rewriting of the agent 202 is not required even though information which is the target to be collected is changed.

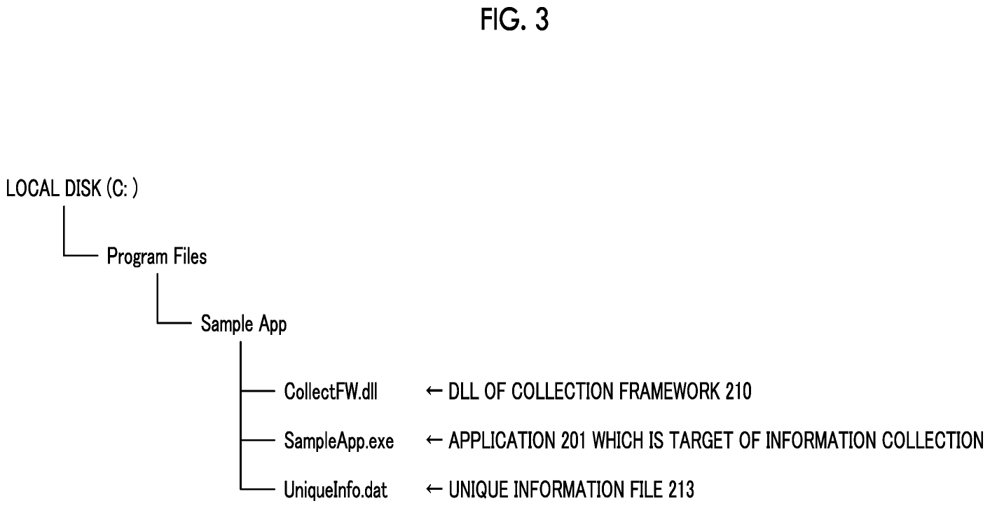

FIG. 3 is a diagram for explaining an arrangement example of the application 201 incorporating the information collection framework 210.

In a case of FIG. 3, the agent 202 is installed in a drive C of a local disk. Therefore, the application 201 is also installed in the same drive as the agent 202.

In the case of FIG. 3, the application 201 is “SampleApp.exe” and is installed in a “Sample App” directory generated under “Program Files”. A dynamic link library (DLL) of the information collection framework 210 and the unique information file 213 are also installed in the same directory.

In the case of FIG. 3, the storage destination of the unique information file 213 is indicated by “C:¥Program Files¥SampleApp¥UniqueInfo.dat”. Accordingly, the above-described storage destination information notification unit 212 (refer to FIG. 2) notifies the agent 202 of this position.

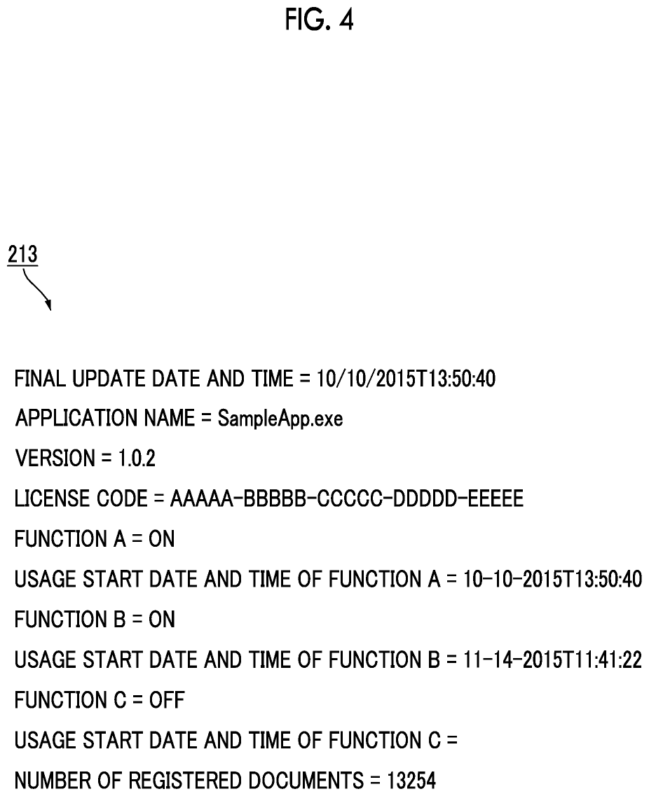

FIG. 4 is a diagram showing a specific example of the unique information file 213.

In the case of the exemplary embodiment, the unique information file 213 is described in a data format by a key and a value. The condition required for the unique information file 213 is only that the unique information file matches the file format treated by the agent 202 (refer to FIG. 2). That is, it is not required to describe the unique information file 213 in a file format by javascript (registered trademark) object notation (JSON), extensible markup language (XML), or the like.

Thus, the agent 202 is able to treat the information collected from each application 201 without being conscious of the content or format of the unique information.

The unique information file 213 shown in FIG. 4 also includes information on individual functions constituting the application 201, and information on the application itself or information that dynamically changes in accordance with an execution of each function in addition to static information such as a name, a version, a license code, and the like of the application 201 (refer to FIG. 2) which is a target of information collection.

For example, it is found that the function A is currently on and the usage start date and time thereof is “2015-10-10T13:50:40”, the function B is also currently on and the usage start date and time thereof is “2015-11-14T11:41:22”, and the function C is currently off.

In the example shown in FIG. 4, it is also found that the final update date and time of the application 201 is “2015/10/10T13:50:40” and the number of registered documents is “13254”.

The unique information file 213 is able to include the total usage time of the application 201, the total usage time of each function, the number of persons using the application 201 or each function, and the like.

As described above, the contents of the information recorded in the unique information file 213 is able to be freely set by the vendor of the application 201. Moreover, by the update of the information update API 211, the contents of the information stored in the unique information file 213 are also changed. In a case where the collected information is changed, correction or the like of the agent 202 is not required.

The description returns to FIG. 2.

The agent 202 resides in the client terminal 20, collects information from each application 201 at preset timing, and transmits the collected information to the collected information management server 30. In the case of the exemplary embodiment, the timing of collecting information from each application 201 is the same as the timing of transmitting the collected information to the collected information management server 30. In other words, the information is collected from each application 201 at the timing of transmitting the collected information to the collected information management server 30.

The agent 202 according to the exemplary embodiment is a program that does not depend on the vendor of an application 201. Further, the agent 202 is able to be used regardless of not only the difference in the application 201 but also the difference in the version. In other words, the agent 202 according to the exemplary embodiment is able to collect any information from any application 201 without any correction.

The agent 202 in the exemplary embodiment has a storage destination information management unit 220, a unique information file reading unit 221, an information transmission unit 222, and a collection setting management unit 223.

The storage destination information management unit 220 executes a function of registering and managing storage destination information of the unique information file 213 notified from each application 201 in a storage destination information DB 220A. The storage destination information management unit 220 also executes a function of giving the information on the storage destination being a target of a request to the unique information file reading unit 221 based on the request from the unique information file reading unit 221.

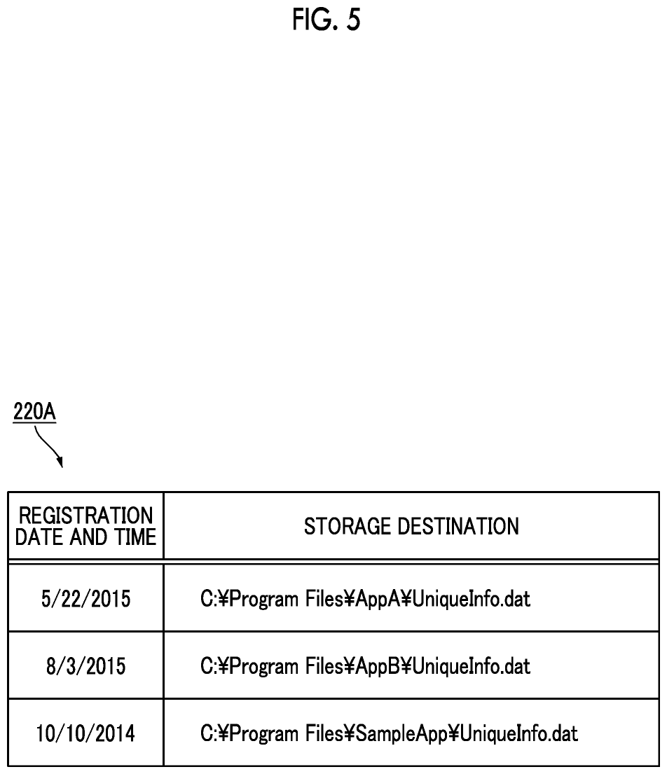

FIG. 5 is a diagram for explaining an example of a structure of the storage destination information DB 220A. The storage destination information DB 220A shown in FIG. 5 manages the unique information file 213 (refer to FIG. 2) that stores information unique to each application by a registration date and time and the storage destination. In the case of FIG. 5, storage destinations are registered for three applications 201 of “AppA”, “AppB”, and “SampleApp”.

The description returns to FIG. 2.

The unique information file reading unit 221 provides a function of acquiring the unique information file 213 from the storage destination notified to each application 201, reading recorded information from the acquired unique information file 213, and giving the information to the information transmission unit 222. In addition, the unique information file 213 to be acquired is instructed by the information transmission unit 222.

The information transmission unit 222 executes a function of transmitting information collected according to a predetermined schedule to the collected information management server 30.

The collection setting management unit 223 uses a setting information DB 223A to manage the timing (hereinafter, referred to as “transmission timing”) of transmitting information collected from the application 201 to the collected information management server 30 and the transmission destination of the collected information.

In the case of the exemplary embodiment, information on the transmission timing and the transmission destination is recorded in a setting information DB 223A. Therefore, it is not required to manage the transmission timing and the transmission destination of the collected information for each application 201. That is, in the case of the exemplary embodiment, only by designating the transmission timing and transmission destination of the collected information in the agent 202, the transmission of information of a certain application 201 is able to be managed.

The collected information management server 30 collects and manages the information of the client terminal 20 determined as the target through the network 10 and provides services such as search and information reference.

The collected information management server 30 in the exemplary embodiment includes an information reception unit 301, a collected information reference unit 302, and a collected information DB 303 for recording the collected information.

The information reception unit 301 executes a function of recording information received from the agent 202 residing on the client terminal 20 in the collected information DB 303.

The collected information reference unit 302 executes a service of acquiring and providing information corresponding to the designation from an operator terminal (not shown) from the collected information DB 303.

Hereinafter, an example of a processing operation executed in the information processing system 1 will be described.

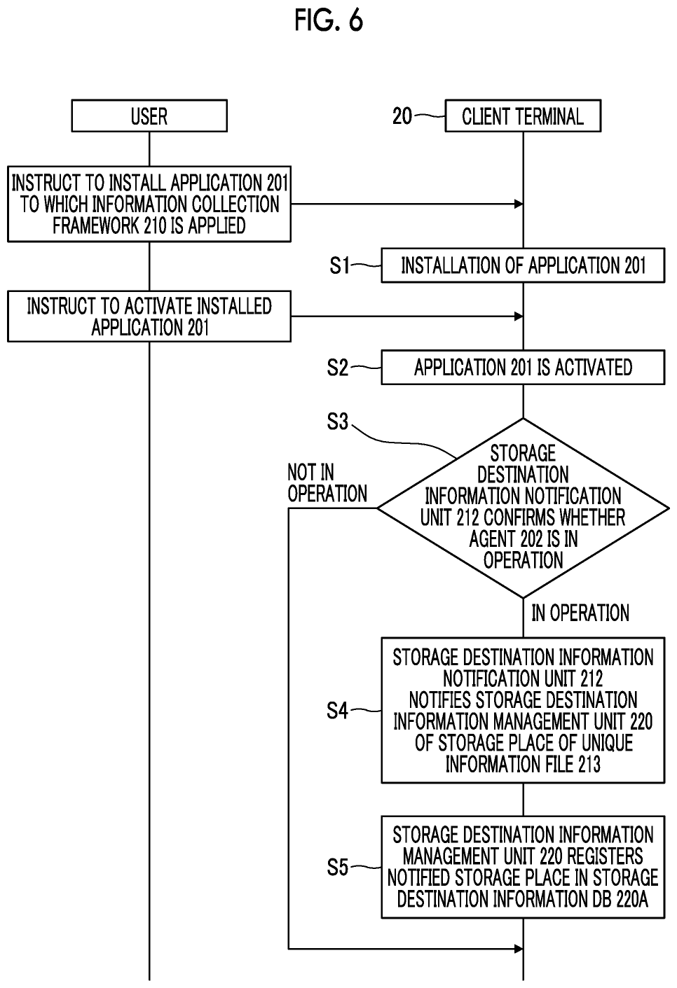

FIG. 6 is a diagram for explaining a processing operation example in a case where a new application 201 is installed in the client terminal 20. The symbol S shown in the drawing means a step.

In a case where the user instructs an installation of the application 201 to which the information collection framework 210 is applied, the installation of the application 201 by the client terminal 20 is executed (Step S1).

In the case of the exemplary embodiment, the information collection framework 210 for collecting information of the application 201 is incorporated in the application 201. Therefore, even though the installation is completed, the collection of information is not executed while the application 201 is not activated and the storage place of the unique information file 213 is not notified to the agent 202 as described later.

In a case where the user instructs the activation of the installed application 201, the client terminal 20 activates the instructed application 201 (Step S2).

In a case where the application 201 is activated, the storage destination information notification unit 212 confirms whether the agent 202 is in operation (Step S3).

In a case where the agent 202 is in operation, the storage destination information notification unit 212 notifies the storage destination information management unit 220 of the storage place of the unique information file 213 (Step S4). The storage destination information management unit 220 is a functional unit of the agent 202.

Next, the storage destination information management unit 220 registers the notified storage place in the storage destination information DB 220A (Step S5).

In a case where the agent 202 is not in operation, Step S4 and S5 are skipped in the client terminal 20. In this case, the notification or the like of the storage place of the unique information file 213 is postponed to the next activation.

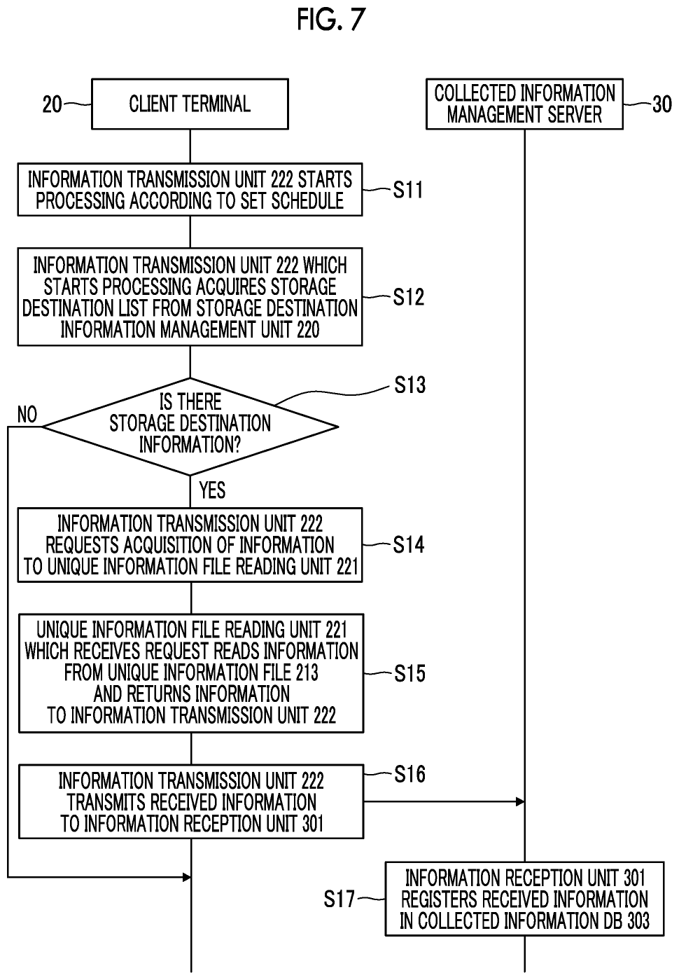

FIG. 7 is a diagram for explaining an example of a processing operation executed on the client terminal 20 after activating the application 201.

The processing shown in FIG. 7 is individually executed for the active application 201.

In the client terminal 20, the information transmission unit 222 of the agent 202 starts processing according to the set schedule (Step S11).

The information transmission unit 222 which starts the processing acquires a storage destination list from the storage destination information management unit 220 (Step S12).

Next, the information transmission unit 222 determines whether there is storage destination information (Step S13).

In a case where there is no storage destination information, the information transmission unit 222 obtains a negative result in Step S13. In this case, since there is no information to be transmitted to the collected information management server 30, the information transmission unit 222 ends the processing at this point in time.

On the other hand, in a case where there is storage destination information, the information transmission unit 222 obtains an affirmative result in Step S13. In this case, the information transmission unit 222 requests the acquisition of information to the unique information file reading unit 221 (Step S14).

The unique information file reading unit 221 which receives the request reads the information from the unique information file 213 and returns the information to the information transmission unit 222 (Step S15).

The information transmission unit 222 which receives the reply transmits the received information to the information reception unit 301 (Step S16). That is, the information collected by the agent 202 is notified to the collected information management server 30.

The information reception unit 301 registers the received information in the collected information DB 303 (Step S17).

The described-above operation is repeatedly executed during the activation of any application.

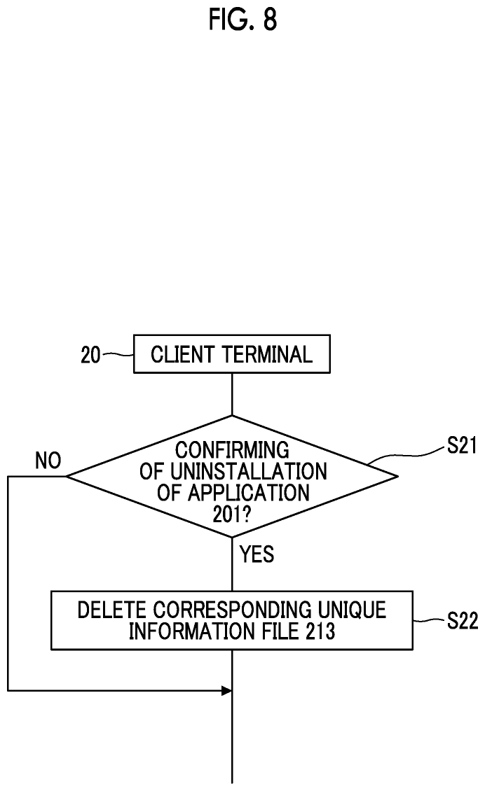

FIG. 8 is a diagram for explaining an example of a processing operation in a case where the application 201 is uninstalled from the client terminal 20.

As shown in FIG. 8, the client terminal 20 confirms whether an uninstallation of the application 201 is executed (Step S21).

In a case where the affirmative result is obtained in Step S21, the client terminal 20 deletes the corresponding unique information file 213 (Step S22). In a case where the unique information file 213 is deleted, the agent 202 is not able to read information from the storage destination managed by the storage destination information management unit 220. That is, after the application 201 is uninstalled, the agent 202 is not able to collect the information of the corresponding application 201. As a matter of course, the information of the application 201 is not transmitted to the collected information management server 30. Moreover, the change of the agent 202 is not required for this operation.

In a case where a negative result is obtained in Step S21, the client terminal 20 skips Step S22 and ends the current operation.

### OTHER EXEMPLARY EMBODIMENT

Although the exemplary embodiment of the present invention is described above, the technical range of the invention is not limited to the range described in the exemplary embodiment described above. It is clear from the description of the claims that the exemplary embodiment described above includes various modifications or improvements in the technical range of the invention.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A non-transitory computer readable medium storing an application program causing a computer to execute:
a function of generating a file including both or one of information related to an individual function of the application program and information dynamically changing in accordance with an execution of the application program or the individual function; and
a function of notifying a software agent residing on the computer of a place where the file is stored.

2. The non-transitory computer readable medium storing an application program according to claim 1,
wherein the place is notified to the software agent after the application program is started.

3. The non-transitory computer readable medium storing an application program according to claim 1,
wherein the file is deleted when the application program is uninstalled.

4. The non-transitory computer readable medium storing an application program according to claim 1,
wherein information recorded in the file is changed at the time of an update or a version upgrade of the application program.

5. A non-transitory computer readable medium storing a software agent causing a computer to execute:
a function of receiving a notification of a place where a file including both or one of information related to an individual function of an application program and information dynamically changing in accordance with an execution of the application program or the individual function is stored, from each application program which is a target to be collected;
a function of reading the file from the notified place; and
a function of transmitting contents of the read file to a designated transmission destination.
